(19) United States
(12) Patent Application Publication
(10) Pub. No.: US 2010/0127514 A1
(43) Pub. Date: May 27, 2010

(54) Door Locking Device, in Particular for Insulating Glass Doors of Cold Rooms, Refrigeration Cabinets and Domestic Refrigerators

(76) Inventor: Rickard Nilsson, Balduinstein (DE)

Correspondence Address: PRYOR CASHMAN, LLP, 7 Times Square, NEW YORK, NY, 10036-6569, US

(21) Appl. No.: 12/599,028

(22) PCT Filed: Mar. 7, 2008
(86) PCT No.: PCT/DE2008/000315

§ 371 Date: Nov. 5, 2009

(30) Foreign Application Priority Data
Dec. 4, 2007 (DE) 10 2007 058 594.4

(51) Int. Cl. E05C 19/08; E05C 19/00

(52) U.S. Cl. 292/252; 292/285

(57) ABSTRACT

The door locking device, in particular for insulating glass doors of cold rooms, refrigeration cabinets and domestic refrigerators (1/2), uses the predetermined door systems which have a plate (3) at the lower hinge-like attachment to the door and also have a plate on the doorframe. A further plate (5) is attached, with an exact fit, to the frame plate, said further plate having, in a cylindrical formation (6), a ball (7) on which the plate of the door (3) rests in the closed state and, in the open state, locks the door, wherein the ball (7) is located in a lubricant reservoir (8).

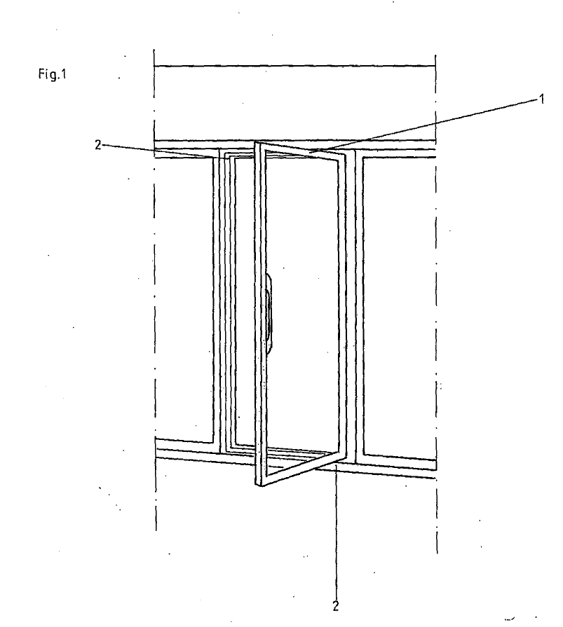

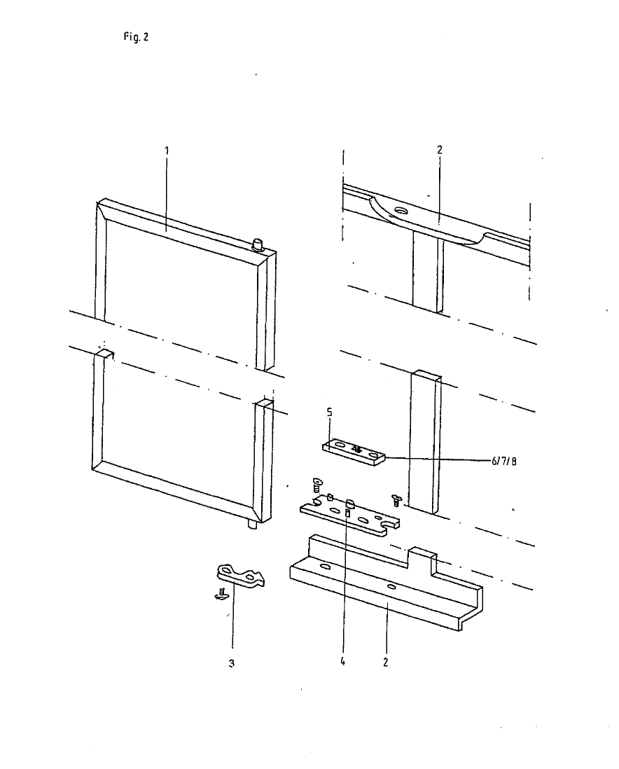

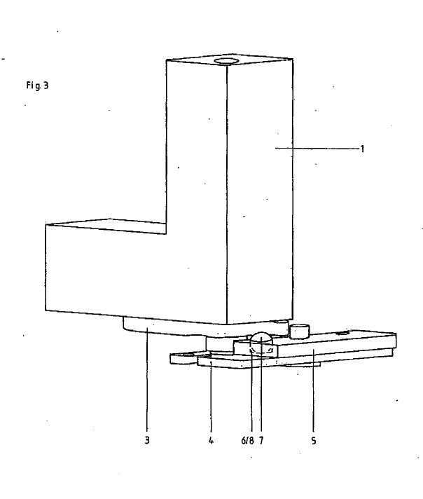

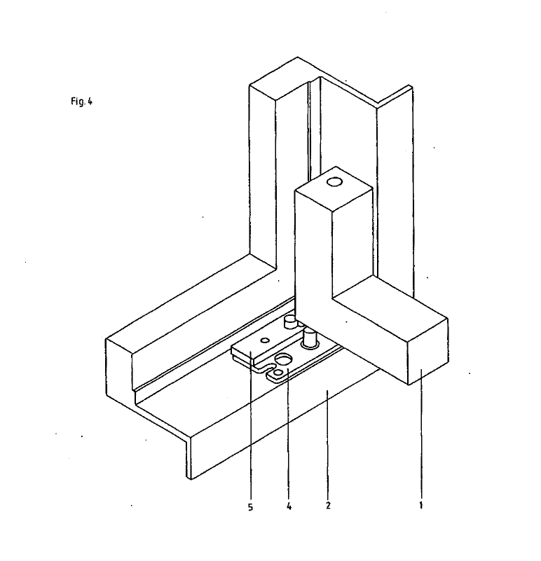

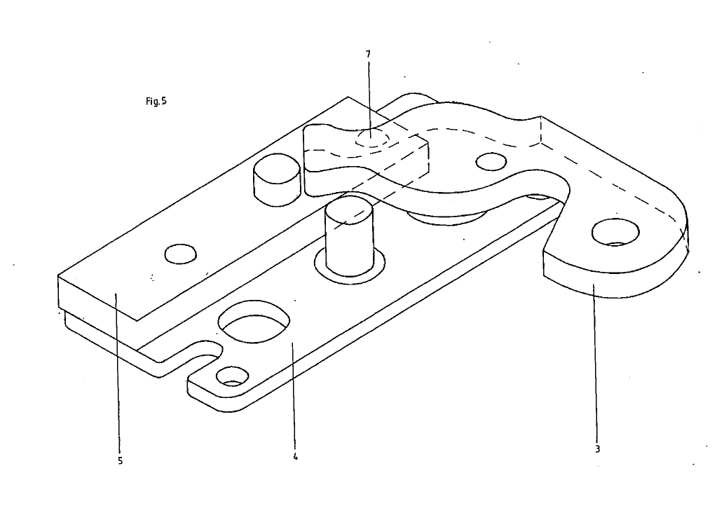

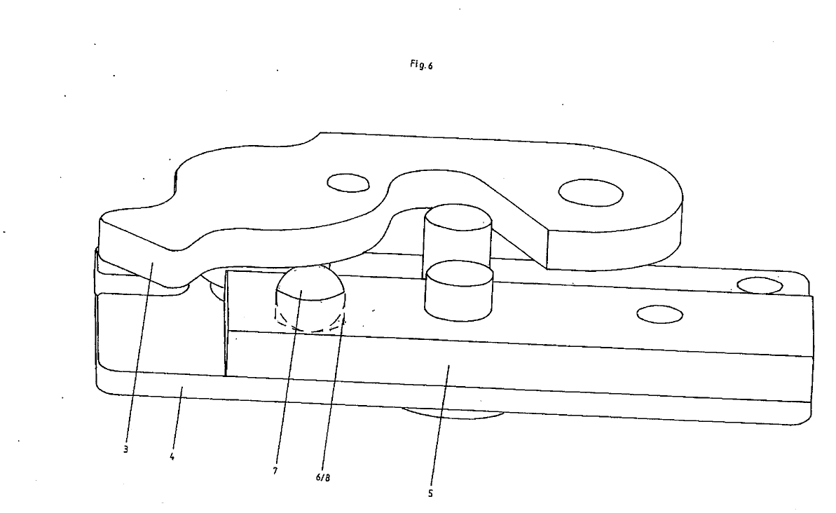

The door stopping devices especially for glass insulation doors of cold rooms and refrigeration equipment and refrigerator cabinets (1/2) uses existing door systems where a panel is attached to the door (3) at the lower door closing mechanism with a plate also on the door frame. A further panel (5) is attached to the door frame which fits exactly to this and which has a ball (7) in a cylindrical shape (7) and which lies on the door plate (3) in a closed state and which locks the door in an opened state, where the ball (7) is located in a lubrication reservoir (8).

The invention concerns a door holding or locking mechanism which is used. For example, for cold rooms and refrigeration equipment and refrigeration equipment. We are concerned here with the door of a refrigeration unit, for example, which can be locked into position in order to remove and fill goods at a specified opening angle without any further operating procedures. Such as using a hook, for example and so that unimpeded access can be gained to the refrigeration unit.

Systems known up to now have a forked-type device fitted in the upper hinge between the door and the door frame with a pin fed through at the door with the fork-type device locking into a notched recess. These systems are subjected to heavy friction so that they have a short working life. These systems can also not be readjusted, since there are no devices existing on conventional glass insulation doors and frames for installing the components. This solution also requires space in the upper horizontals between the door and the frame which usually do not exist. These solutions only work with a hook and complicated in their manufacture.

Other solutions (EP 0 111 019) place a spring in the lower hinge in the door frame wits a shape which matches with existing components such as door hinge plates, so that the door is held in an open state by the spring. Heavy friction also occurs here between the spring and the plate during opening and closing movements, leading to material fatigue for the spring, leading to heavy wear and tear on the spring until it is destroyed. These solutions are problematical because of uncomfortable feel when locking into position and also the related generation of loud noise.

The invention stated in patent claim 1 is based on the problem of creating a Door stopping device which works more or less without wear and tear to guarantee a long working life. The invention should also be useable on already existing doors and frames without any further technical expenditure; it should work noiselessly to give the operator the feel of a top class car door.

These problems will be solved by the features listed in patent claim 1.

The advantages gained by the invention consist especially of the fact that the extra plate (6) with the ball (7) located on it only need to be inserted in the existing door frame (2) and doors (2). Advantage is taken of the fact here that cooling unit doors and frames readily obtainable on the market always have hinge plates (3/4) detailed in patent claim 1, with the advantage that plates fit into conventional systems or can be retrofitted. The narrow space for the panel already exists since all the commercially obtainable doors and frames have enough space at the top and so that the plate with the ball can be inserted at the lower hinge without having to create extra space at the upper frame.

A further advantageous aspect of the design arises from patent claims 2 and 3. The door with the plate (3) in a closed state on the ball (7), the door plate moves over the ball (7) in a closed state when the door is opened and the hinge plate stops the door when a specified opening angle has been reached, preferably 90°, so that the door lower slightly and is held in position by the ball and the hinge plate (DIAGRAM III) (DIAGRAM V).

A slight resistance is generated by the hinge plate (3) of the door meeting with the ball (7) when the door is closed. The door is pushed and rolls on the ball with practically no resistance at all in the closed state (DIAGRAM VI).

Use of the ball (7) in claim 3 guarantees the intended comfortable and high value feel and practically wear-free operation with a practically limitless working life.

A further advantageous aspect of the design is to be found in claim 4, since the cylindrical hole is not only used for seating the ball but is also used as a reservoir for lubricant—

An example of use is shown in diagrams 1-VI and is described in more detail as follows:

Diagram 1 shows a glass insulating door with the hinge fitted.

Diagram 1 shows all the elements of the invention, namely the door (1), the door frame (2), the plate of the door (3) and the plate of the plate (4) the new plate to be fitted (6), the ball attached there (7) with reservoir (8) in a non-assembled state.

Diagram III shows the door with the plates (3), (4) and (5) in the opened state where the ball (7) locks the door into position.

Diagram IV shows a cross section of invention.

Diagram V shows the panels of the door (3) and the frame (4) and the new attached plate, also in the closed state where the ball holds the plate of the door (3) in position.

Diagram VI shows the invention with the plates (3), (4) and (5) in a closed state where the plate of the door (3) lies on the ball (7).

1. Door stopping device for a door (1) mounted in a door frame (2) on one side on top and below in said frame and capable to move like a hinge between the closed and open position, in which the door, on its lower hinge-like fixture, has a device with a plate (3) fastened on the lower part of the door and moving along with the door, in which the door frame also having a plate (4) mounted directly underneath the door, characterized by another plate (5) being stuck onto the plate of the door frame, which plate (5) having such borings that the said borings fit exactly onto the pins of the door frame and do not move along with the door.

2. Door stopping device according to claim 1 characterized by the plate (5) stuck onto the plate of the door frame (4) having another cylindrical boring (6) not completely bored through and located, when the door is closed, underneath the plate of door (3).

3. Door stopping device according to claim 1 characterized by a steel ball (7) being embedded in the cylindrical boring (6) not completely bored through of plate (5) which is stuck onto the plate of door frame (4) on which the plate of the door rests.

4. Door stopping device according to claim 3 characterized by a clearance (8) located between the ball and the cylindrical boring, and filled with lubricant.
